(19) United States
(12) Patent Application Publication
(10) Pub. No.: US 2026/0237285 A1
(43) Pub. Date: Aug. 13, 2026

(54) AUTOMATED DETECTION OF POWER LINE DISCONNECTION EVENTS AND LOCAL ALERTS USING WIRELESS PROCEDURES

(71) Applicant: Charter Communications Operating, LLC, St. Louis, MO (US)

(72) Inventor: Venkata Ramana Divvi, Centennial, CO (US)

(21) Appl. No.: 19/051,802

(22) Filed: Feb. 12, 2025

(51) Int. Cl. G08B 21/18; H04B 3/54

(52) U.S. Cl. CPC G08B 21/185; H04B 3/54; H04B 2203/5404

(57) ABSTRACT

A real-time message is received from a first of a plurality of power sensors. Each of the plurality of power sensors are operable to measure electrical infrastructure elements located within a particular geographic area. The real-time message is indicative of occurrence of a power line disconnection event within the particular geographic area. Based on the location of the first power sensor, mapping information associated with the geographic area is evaluated to identify a portion of the geographic area in which the power line disconnection event occurred. One or more remedial actions are performed responsive to the occurrence of the power line disconnection event. To do so, a subset of computing devices located within the portion of the geographic area are identified from a set of computing devices located within the geographic area, and real-time safety notifications are transmitted to computing devices located within the portion of the geographic area.

### BACKGROUND

Energy providers use energy distribution systems to provide energy to commercial and residential areas. Energy distribution systems function by generating energy at one location and then carrying that energy to other locations via electrical infrastructure elements. Examples of electrical infrastructure elements include power distribution structures (e.g., primary distribution lines for high-voltage power), step-down or step-up transformers, power line support structures (i.e., power poles or electric poles, etc.), and other infrastructure elements. Typically, power line support structures are placed closest to the areas they serve. For example, to carry power to homes in a neighborhood, power line support structures will usually be placed throughout the neighborhood. In turn, the power carried by the power line support structures may be provided by a step-down transformer that is supplied by a power distribution structure.

### SUMMARY

In one implementation, a method is provided. The method includes receiving, by a computing system comprising one or more processor devices, a real-time message from a first power sensor of a plurality of power sensors, wherein each of the plurality of power sensors are operable to measure electrical infrastructure elements located within a particular geographic area, and wherein the real-time message is indicative of occurrence of a power line disconnection event within the particular geographic area. The method further includes based on the location of the first power sensor, evaluating mapping information associated with the geographic area to identify a portion of the geographic area in which the power line disconnection event occurred. The method further includes performing, by the computing system, one or more remedial actions responsive to the occurrence of the power line disconnection event. Performing the one or more remedial actions includes identifying, by the computing system, a subset of computing devices located within the portion of the geographic area from a set of computing devices located within the geographic area. Performing the one or more remedial actions further includes transmitting, by the computing system, real-time safety notifications to at least one of the subset of computing devices located within the portion of the geographic area.

In another implementation, a computing system is provided. The computing device includes a memory, and one or more processor devices coupled to the memory. The processor device(s) are to receive a real-time message from a first power sensor of a plurality of power sensors, wherein each of the plurality of power sensors are operable to measure electrical infrastructure elements located within a particular geographic area, and wherein the real-time message is indicative of occurrence of a power line disconnection event within the particular geographic area. The processor device(s) are further to, based on the location of the first power sensor, evaluate mapping information associated with the geographic area to identify a portion of the geographic area in which the power line disconnection event occurred. The processor device(s) are further to perform one or more remedial actions responsive to the occurrence of the power line disconnection event. To perform the one or more remedial actions, the processor device(s) are to identify a subset of computing devices located within the portion of the geographic area from a set of computing devices located within the geographic area. To perform the one or more remedial actions, the processor device(s) are further to transmit real-time safety notifications to at least one of the subset of computing devices located within the portion of the geographic area.

In another implementation, a non-transitory computer-readable storage medium is provided. The non-transitory computer-readable storage medium includes executable instructions to cause one or more processor devices to receive a real-time message from a first power sensor of a plurality of power sensors, wherein each of the plurality of power sensors are operable to measure electrical infrastructure elements located within a particular geographic area, and wherein the real-time message is indicative of occurrence of a power line disconnection event within the particular geographic area. The instructions further cause the processor device(s) to, based on the location of the first power sensor, evaluate mapping information associated with the geographic area to identify a portion of the geographic area in which the power line disconnection event occurred. The instructions further cause the processor device(s) to perform one or more remedial actions responsive to the occurrence of the power line disconnection event. To perform the one or more remedial actions, the processor device(s) are to identify a subset of computing devices located within the portion of the geographic area from a set of computing devices located within the geographic area. To perform the one or more remedial actions, the processor device(s) are further to transmit real-time safety notifications to at least one of the subset of computing devices located within the portion of the geographic area.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an energy distribution environment suitable for implementing automated detection of power line disconnection events and local alerts using wireless procedures according to some implementations of the present disclosure.

FIG. 2 is a communication flow diagram for automated detection of power line disconnection events and local alerts using wireless procedures according to some implementations of the present disclosure.

FIG. 3 illustrates an example power line disconnection event and corresponding real-time alerts according to some implementations of the present disclosure.

FIG. 4 depicts a flow chart diagram of an example method to perform automated detection of power line disconnection events and local alerts using wireless procedures according to some implementations of the present disclosure.

FIG. 5 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Energy service providers use energy distribution systems to provide energy to commercial and residential areas. Energy distribution systems function by generating energy at one location and then carrying that energy to other locations via electrical infrastructure elements. Examples of electrical infrastructure elements include power distribution structures (e.g., primary distribution lines for high-voltage power), step-down or step-up transformers, power line support structures (e.g., power poles, etc.), and other infrastructure elements. Typically, power line support structures are placed closest to the areas they serve. For example, power line support structures that carry power to homes in a neighborhood will usually be placed within that neighborhood. In turn, the power carried by the power line support structures may be provided by a step-down transformer that is supplied by a power distribution structure located outside the neighborhood. In such scenarios, the placement of power line support structures within the neighborhood is typically sufficiently dense as to provide redundancy in case a power line disconnection event occurs (e.g., a power line being “downed” by a falling tree, an automobile crash, etc.).

The type, quality, and/or quantity of electrical infrastructure elements placed within a particular geographic area can vary drastically based on the energy requirements of the area and the capabilities of the entity placing the electrical infrastructure elements. Given a high-tech commercial office area in a highly developed country, a power distribution entity will usually place redundant or “backup” electrical infrastructure elements to maintain continuous power delivery in the case of component failure or inclement weather. In addition, power line support structures may be buried underground or otherwise “reinforced” to protect against the threat of power line disconnection events.

Conversely, in areas that are sparsely populated or are less economically developed, it is relatively common for power line support structures to be placed in a “single-file” sequence (e.g., without the use of any redundancies or backup systems) to carry energy to remote locations. In such scenarios, if a power line support structure suffers a power line disconnection event, the flow of power to any power line support structures in the sequence downstream of the affected support structure can be disrupted. In turn, a break in the “single-file” sequence can lead to power disruptions across a wide area. Furthermore, downed power lines present a serious risk of death if directly contacted by humans or animals, and can also cause fires.

Unfortunately, the above-noted deficiencies are exacerbated by the difficulty of identifying specific power line support structures that have suffered power line disconnection events. For example, when power-line support structures are placed in a single-file sequence, and a power line disconnection event occurs (e.g., a tree knocks down a power line, etc.), it can be difficult to determine the precise location of the disconnection event, as the disconnection can also affect every structure “downstream” of the affected structure. In such instances, energy service providers cannot accurately identify the location power line disconnection events until the event is reported by affected subscribers. Until the event is remedied, however, downed power lines can substantially disrupt energy provision and can serve as a substantial danger to those located nearby.

Accordingly, implementations described herein propose automated detection of power disconnection events and local alerts using wireless signaling across multiple communication platforms (e.g., wireless networks, cable networks, social media platforms, etc.). More specifically, implementations described herein propose efficient power sensor deployment to enable real-time detection and identification of power line disconnection events. For example, assume that a power line disconnection event happens within a particular geographic area. Further assume that power sensors operable to monitor electrical infrastructure are located within the particular geographic area. A computing system (e.g., a computing system associated with an energy service provider or network service provider) can receive a real-time message from a first power sensor of the plurality of power sensors. The real-time message is indicative of occurrence of a power line disconnection event within the particular geographic area.

As described herein, a “power sensor” refers to a sensor operable to measure electricity being carried via electrical infrastructure. A power sensor can determine if power is currently being carried by a corresponding element of electrical infrastructure. For example, a power sensor may be mounted to a power line support structure (e.g., a power pole) to monitor whether electricity is being carried via the power line support structure. In some instances, power sensors can measure and record metrics related to power delivery.

In some implementations, a power sensor can be operable to report directly to the computing system if the power sensor fails to measure electricity being carried by a corresponding power line support structure (e.g., the structure on which the power sensor is placed, etc.). For example, the power sensor may use Fifth Generation New Radio (5G NR) technologies to wirelessly signal the real-time message to the computing system. Alternatively, in some implementations, power sensor can be operable to routinely exchange real-time messages via local signaling, with some power sensors being designated as “monitor” power sensors that monitor other power sensors. If the first power sensor is a monitor power sensor, the monitor power sensor may send the real-time message to the computing system if the monitor power sensor does not receive an expected message from another power sensor that it monitors.

The computing system can determine a location of the power sensor that sent the real-time message. In some implementations, the computing system may determine the location based on location information that indicates a location of each of the power sensors. Based on the location of the power sensor, the computing system can evaluate mapping information associated with the geographic area to identify a particular portion of the geographic area in which the power line disconnection event occurred. For example, if the first power sensor is located in a particular neighborhood, the computing system may evaluate the mapping information to identify the neighborhood as the particular portion of the geographic area.

The computing system can perform one or more remedial actions responsive to the power line disconnection event. More specifically, the computing system can identify a subset of computing devices located within the portion of the geographic area from a set of computing devices located within the geographic area. The subset of computing devices can be user devices, Customer Premises Equipment (CPE), etc. that are likely to be affected by the power line disconnection event. To follow the previous example, the computing system may identify the user devices associated with users living in the neighborhood (and/or visiting users currently located in the neighborhood) in which the power line disconnection event occurred. The computing system can then transmit real-time safety notifications to the subset of computing devices.

Additionally, or alternatively, in some implementations, the computing system can perform a variety of other remedial actions in response to the power line disconnection event. For example, the computing system can transmit real-time instructions to instruct maintenance personnel to repair the power line support structure. For another example, the computing system can interface with public access networks, cable television networks, emergency alert systems, etc. to transmit real-time safety alerts. For yet another example, the computing system can cause power delivery to the electrical infrastructure monitored by the first power sensor to temporarily cease until repairs are complete. In such fashion, implementations described herein enable rapid and efficient remediation of power line disconnection events.

Aspects of the present disclosure provide a number of technical effects and benefits. As one example technical effect and benefit, implementations described herein enable efficient detection and location of power line disconnection events in scenarios with low monitoring coverage. For example, conventional approaches rely on planned redundancies and specialized systems to detect and remedy power line disconnection events. However, such approaches cannot be effectively implemented in certain areas, such as rural areas or less-developed areas. By enabling efficient and accurate detection of power line disconnection events via efficient placement of power sensors, implementations described herein can detect and locate power line disconnection events and perform remedial actions in real-time. In turn, real-time remediation of power line disconnection events can substantially reduce the duration of power disruptions and can improve safety for people nearby.

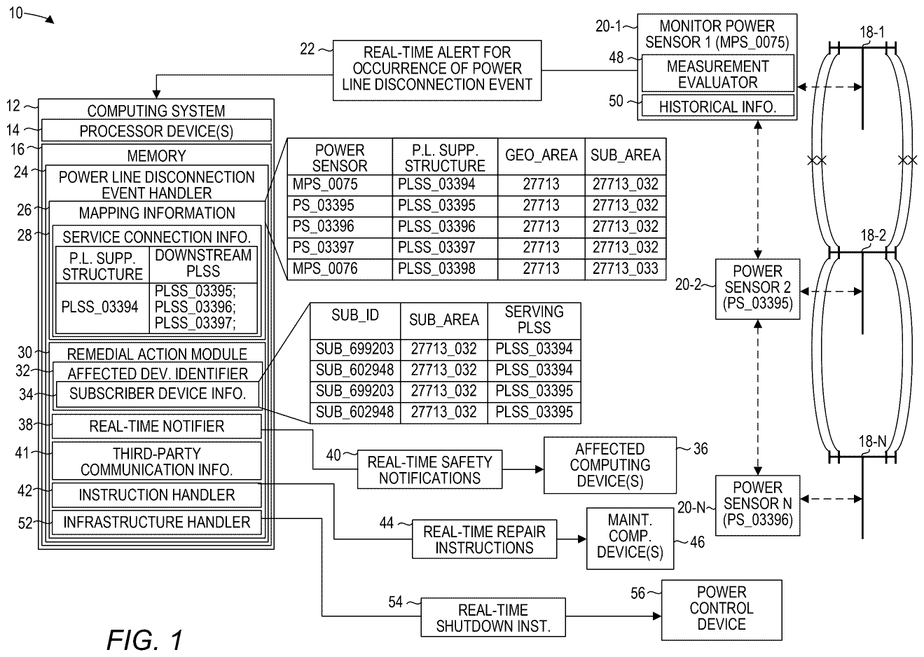

FIG. 1 is a block diagram of an energy distribution environment 10 suitable for implementing automated detection of power line disconnection events and local alerts using wireless procedures according to some implementations of the present disclosure. An energy distribution environment 10 can include a computing system 12 with one or more processor device(s) 14 and a memory 16. As described herein, the “energy distribution environment” 10 can be, or include, a computing environment (e.g., a collection of computing devices, systems, and related infrastructure associated with a particular entity or organization) along with electrical infrastructure elements that facilitate the provision of energy services (e.g., transformers, power line support structures, etc.). For example, the energy distribution environment 10 can include a confidential computing “enclave” that leverages hardware-based execution environments and secure virtualization technologies, such as memory encryption, to isolate critical computations and prevent unauthorized access to data while in use. For another example, the energy distribution environment 10 can include a distributed computing environment that utilizes computing resources across a variety of different types of devices (e.g., servers, virtualized devices, user devices, Internet-of-Things (IoT) devices, etc.).

Additionally, or alternatively, in some implementations, the energy distribution environment 10 can include a cloud computing environment implemented using the computing system 12. For example, the computing system 12 can implement a cloud computing platform by implementing a variety of cloud modules to provide cloud functionality. The cloud computing platform implemented by the computing system 12 can be utilized by various users, entities, organizations, devices, etc. within (and/or external to) the computing environment 10.

In some implementations, the computing system 12 may be a computing device that includes multiple computing devices (i.e., a computing system). Alternatively, in some implementations, the computing system 12 may be one or more computing devices within a computing system that includes multiple computing devices. Similarly, the processor device(s) 14 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 16 can include a containerized unit of software instructions (i.e., a “packaged container”). The containerized unit of software instructions can collectively form a container that has been packaged using any type or manner of containerization technique.

A containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In some implementations, the energy distribution environment 10 can include multiple types of nodes. As described herein, a “node” generally refers to a discrete unit of hardware and/or software resources. In some instances, nodes within the energy distribution environment 10 can be configured to perform specific tasks. For example, some nodes within the energy distribution environment 10 can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes can be allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

The energy distribution environment 10 can include electrical infrastructure elements, such as transformers, power line support structures, energy generation stations, high-voltage support structures, etc. In particular, the energy distribution environment 10 can include a plurality of power line support structures 18-1-18-N (generally, power line support structures 18). The power line support structures 18 can be, or otherwise include, physical support structures (e.g., a pole, a mounting point for an existing surface, etc.) and any necessary electrical infrastructure elements (e.g., distribution transformers, etc.). For example, the power line support structure 18-1 may be a tall wooden pole which carries power lines at a certain height. For another example, the power line support structure 18-2 may be an attachment point mounted to an existing surface (e.g., the side of an existing building, etc.).

The energy distribution environment 10 can further include a plurality of power sensors 20-1-20-N (generally, power sensors 20). In some implementations, each of the power sensors 20 can be assigned to monitor a corresponding power line support structure of the power line support structures 18. For example, the power sensor 20-1 can monitor the power line support structure 18-1, the power sensor 20-2 can monitor the power line support structure 18-2, etc.

The power sensors 20 can be communicatively coupled to their corresponding power line support structures. In some implementations, a power sensor can be physically mounted to a corresponding power line support structure. For example, the power sensor 20-1 may be physically placed near the top of the power line support structure 18-1. Additionally, or alternatively, in some implementations, a power sensor can be placed proximally to the power line support structure. For example, the power sensor 20-2 may be placed adjacent to the power line support structure 18-2 (e.g., near the bottom of the structure, atop the power lines supported by the structure, etc.).

The power sensors 20 can be operable to measure electrical infrastructure elements such as the power line support structures 18. More specifically, the power sensors 20 can measure the power line support structures 18 to determine whether the power lines supported by the power line support structures 18 are active (i.e., actively carrying energy). As such, it should be understood that a power sensor can be placed at any distance from a corresponding power line support structure sufficient to enable the power sensor to measure whether electricity is being received at the support structure.

Generally, the power sensors 20 can use any type or manner of communications technology to exchange information (e.g., Power Line Communication (PLC), Wi-Fi point-to-point daisy-chained links, SMS integration, subscription-based event notifications integrations with Wide-area Wireless (e.g. 5G) communication systems, Custom-built Massive Machine Type Communication (mMTC) in 5G, etc.). The power sensors 20 can utilize such communication technologies to communicate with the computing system 12 and/or other power sensors 20. For example, under a normal operating scenario, the power sensors 20 can exchange code “GREEN” health statuses to indicate correct operation. If abnormal conditions are detected by the power sensors 20 (e.g., zero voltage measured, voltage fluctuations measured, high temperature due to lines rupturing with vegetation/trees, etc.), the power sensors can exchange code “RED” health statuses or report to the computing system 12.

In some implementations, the power sensors 20 can include local wireless signaling capabilities. For example, the power sensor 20-1 may communicate with the power sensor 20-2 over via local wireless signaling (e.g., Wi-Fi 802.11, Zigbee, Bluetooth, Ultra-Wideband (UWB), etc.). In some instances, the wireless communication technology leveraged by the power sensors 20 can have a limited range that restricts the power sensors 20 to communicate with only their nearest neighboring power sensors. For example, via local wireless signaling, the power sensor 20-1 may be able to communicate directly with the power sensor 20-2, but the power sensor 20-N may be too distant from the power sensor 20-1 to enable direct communication via local wireless signaling. Alternatively, in some implementations, the power sensors 20 can communicate via wireless network technologies, such as 5G NR, Fourth Generation Long-Term Evolution (4G LTE), etc. In such instances, one power sensor may communicate with another power sensor regardless of distance or range.

Based on the measurements performed by the power sensors 20, the power sensors 20 can determine that a power line disconnection event has occurred. For example, if the power sensor 20-N measures a lack of electricity at the power line support structure 18-N for a predetermined period of time, the power sensor 20-N can generate a real-time alert 22 that indicates the occurrence of a power line disconnection event. As described herein, a power line disconnection event can refer to any event that interferes with the carrying of electricity by power lines supported by a power line support structure. For example, a power line disconnection event can refer to a tree falling during a storm and severing the power lines supported by a power line support structure. For another example, a power line disconnection event can refer to an automobile crashing into a power line support structure and knocking the structure down. For yet another example, a lightning strike, damage from wildlife, etc. may damage a power line or render a power line support structure inoperable.

In some implementations, the power sensors 20 can include monitor power sensors, such as the monitor power sensor 20-1. The monitor power sensor 20-1 can monitor other power sensors of the power sensors 20, such as the power sensor 20-2. Additionally, the monitor power sensor 20-1 can monitor other power sensors while also monitoring a corresponding electrical infrastructure element (e.g., the power line support structure 18-1). For example, assume that the power sensor 20-2 is operable to regularly report measurements of the power line support structure 18-2 to the monitor power sensor 20-1. If the power sensor 20-2 begins to report measurements indicating a lack of electricity, or if the power sensor 20-2 fails to regularly report, the monitor power sensor 20-1 can determine that a power line disconnection event has likely occurred.

The memory 16 of the computing system 12 can include a power line disconnection event handler 24. The power line disconnection event handler 24 can be operable to detect, identify, and remediate power line disconnection events in real-time. The power line disconnection event handler 24 can provide various functionality and perform various operations to ensure correct operation of the energy distribution environment 10. For example, the power line disconnection event handler 24 can maintain mapping information 26 that maps the deployment locations of the power line support structures 18 and/or the power sensors 20.

Other examples of operations performed by the power line disconnection event handler 24 include maintaining the status of each assigned resource for each power line support structure associated with the computing system 12, performing automatic voice calls and text messages to alert specific human organizations responsible for repairing power line disconnection events (e.g., operational/maintenance team members like linemen, etc.), interfacing with a PAS (Public Alerting System) to alert people located close by the location of a power line disconnection event, notifying user devices in the area, interfacing with Cable TV systems, etc. In some implementations, the power line disconnection event handler 24 can autonomously issue commands to line control elements (e.g. Smart Line Transformers (SLT) equipped with the capability to control the relays with remote soft commands) based on real-time alerts received from the power sensors 20. For example, assume that the power line support structure 18-2 is served (i.e., receives power from) a particular SLT. If the power line disconnection event handler 24 receives a real-time alert from the power sensor 20-2 deployed to the power line support structure 18-2, the power line support structure 20-2 can issue a soft command to SLT to shut down the power supply to the reported line until further instructions are received.

Each of the power sensors 20 and the power line support structures 18 can be located in a particular geographic area. For example, each of the power line support structures 18 can be located in the same state, city, town, neighborhood, etc. The power line disconnection event handler 24 can receive the real-time alert 22 from the power sensors 20. In response, the power line disconnection event handler 24 can identify a location of the power sensor that sent the real-time alert 22 (or the location of the power sensor to which the real-time alert 22 relates). For example, if the real-time alert 22 is sent by the power sensor 20-2, and indicates the occurrence of a power line disconnection event at the power line support structure 18-2, the power line disconnection event handler 24 can determine the location of the power sensor 20-2. For another example, if the real-time alert 22 is sent by the power sensor 20-1 and indicates that an expected message was not received by the power sensor 20-1 from the power sensor 20-N, the power line disconnection event handler 24 can determine the location of the power sensor 20-N.

In some implementations, the power line disconnection event handler 24 can determine the location of the corresponding power sensor based on the mapping information. For example, the mapping information 26 can store a deployed location of each of the power sensors 20 and/or the power line support structures 18. Alternatively, in some implementations, the real-time alert 22 can include location information identifying a location of the reporting power sensor.

Assume that the power sensor 20-1 sends the real-time alert 22 to the power line disconnection event handler 24. Based on the location of the power sensor 20-1, the power line disconnection event handler 24 can evaluate the mapping information 26 associated with the geographic area to identify a portion of the geographic area in which the power line disconnection event occurred. For example, as described previously, the power line support structures 18 can be located within a certain geographic area. The power line disconnection event handler 24 can evaluate the mapping information 26 to identify a portion of that geographic area that is most likely the portion in which the power line disconnection event occurred.

For example, assume that the power sensor 20-2 sends the real-time alert 22 to the power line disconnection event handler 24. The power line disconnection event handler 24 can evaluate the mapping information 26 to identify a portion of the geographic area that is likely to be impacted by the power line disconnection event (e.g., may contact a broken power line, may experience power disruptions, etc.). As such, the “portion” of the geographic area identified by the power line disconnection event handler 24 can cover an area predicted to be impacted by the power line disconnection event.

In some implementations, the size and/or coverage of the portion of the geographic area can be adjusted based on the severity of the power line disconnection event, the location of the affected power line support structure, the availability of maintenance personnel, etc. For example, if the power sensor 20-1 reports the real-time alert, and the power line support structure 18-1 monitored by the power sensor 20-1 is located next to a body of water, the power line disconnection event handler 24 may expand the portion of the geographic area to cover the entirety of the body of water to mitigate the risk posed by electrification of the body of water. For another example, if the power line disconnection event handler 24 determines that maintenance personnel are unavailable for an extended period of time (e.g., based on information received from maintenance personnel, historical reaction times, a current time, etc.), the power line disconnection event handler 24 may expand the size of the portion of the geographic area to account for the delayed response (and vice-versa).

In some implementations, the mapping information 26 can include predetermined or pre-identified portions of the geographic area in which the power sensors 20 and/or the power line support structures 18 are located. To follow the depicted example, the power line support structures 18-1, 18-2, and 18-N can be located in a geographic area identified by the zip code 27713. The mapping information 26 can further assign the power line support structures 18-1 and 18-2 to a sub-area “032” of the geographic area 27713 while assigning the power line support structures 18-3 to the sub-area “033” of the geographic area 27713. Based on whether the power sensor 20-2 or 20-3 sends the real-time alert 22, the power line disconnection event handler 24 can identify either the sub-area “032” or “033” as the portion of the geographic area in question.

In some implementations, the mapping information 26 can include service connection information 28. The service connection information 28 can describe or otherwise indicate sequential relationships between the power line support structures 18. More specifically, the service connection information 28 can indicate if a power line support structure is “downstream” or “upstream” of the source of the power being carried by the power lines (e.g., a distribution transformer, a step-down transformer, an energy generation station, etc.). If a power line support structure sends the real-time alert 22, the power line disconnection event handler 24 may expand the portion of the geographic area to include power line support structures “downstream” of the affected power line support structure due to the increased likelihood that the downstream structures are also affected.

The power line disconnection event handler 24 can include a remedial action module 30. The remedial action module 30 can perform remedial actions responsive to the power line disconnection event. In some implementations, the remedial action module 30 can include an affected device identifier 32. The affected device identifier 32 can identify affected devices 36 (e.g., user devices, Customer Premise Equipment (CPE), etc.) associated with persons located within a certain distance from the location of the power line disconnection event. To do so, in some implementations, the affected device identifier 32 can include subscriber device information 34. The subscriber device information 34 can include location information for subscribers to certain services.

For example, upon identifying the affected portion of the geographic area, the affected device identifier 32 can request the subscriber device information 34 from various service providers who provide services to subscribers located within that portion of the geographic area (e.g., the energy distribution service that deployed the power line support structures 18, a network service provider, an internet service provider, etc.). The subscriber device information 34 can indicate a current location and/or a “typical” or “home” location of the device. For example, a current location may be reported for a mobile device while a “home” location may be reported for a CPE. If the reported location for a device is within the portion of the geographic area, the device can be identified by the affected device identifier 32 as one of the affected devices 36.

In some implementations, the affected device identifier 32 can filter devices from the affected devices 36 even if located within the portion of the geographic area. For example, assume that one of the subscriber devices is located within the portion of the geographic area. If the subscriber device is associated with a residence that has its own power source (e.g., via solar panels, a generator, etc.), the affected device identifier 32 may refrain from adding the device to the affected computing devices 36. Alternatively, in some implementations, the affected device identifier 32 can identify every device within the portion of the geographic area as being one of the affected computing devices 36.

The remedial action module 30 can include a real-time notifier 38. The real-time notifier 38 can generate real-time safety notifications 40 for the affected devices 36. The remedial action module 30 can communicate the real-time safety notifications 40 to the affected computing device(s) 36 using any type or manner of communication medium used by the corresponding affected computing devices 36. For example, if the affected computing devices 36 include a Cable Television (CATV) box, the real-time notifier 38 can communicate with CATV service providers to transmit the real-time safety notifications 40 to the affected computing device(s). For another example, if the affected computing devices 36 include a smartphone device, the real-time notifier 38 can use wireless communication services (e.g., a mobile application notification, a text message, etc.) to transmit the real-time safety notifications 40 to the affected computing device(s).

In some implementations, one of the affected computing devices 36 can be unreachable by the real-time notifier, or the affected computing devices 36 may not include a device for a known residence within the portion of the geographic area. In such instances, the real-time notifier 38 can invoke bulk messaging to alert the public in the portion of the geographic area via a wide-area wireless system. For example, the real-time notifier 38 can notify mobile devices attaching to cell sites covering the affected area via an alert on their mobile indicating a power lines outage in area XYZ. For another example, the real-time notifier 38 can leverage a EPAS (Emergency Public Alerting System) to inform people located within the portion of the geographic area. Additionally, or alternatively, the real-time notifier 38 can perform an automated process (e.g., by leveraging a Large Language Model (LLM) or similar) to autonomously generate and publish information to alert the public of the power line disconnection event via internet-based local digital/social media.

In some implementations, the remedial action module 30 can include third-party communication information 41. The third-party communication information 41 can include contact information (e.g., phone numbers, addresses, etc.) of organizations or entities to be automatically contacted by the remedial action module 30. The third-party communication information 41 can also include Application Programming Interface (API)-related information and the like for interfacing with computing systems associated with entities such as maintenance personnel, emergency alert systems, service providers, etc.

In some implementations, the remedial action module 30 can include an instruction handler 42. The instructions handler 42 can generate real-time repair instructions 44 and transmit the real-time repair instructions 44 to maintenance computing device(s) 46 associated with maintenance personnel or maintenance organizations responsible for repairing the power line disconnection event. The real-time repair instructions 44 can include the predicted location of the power line disconnection event to expedite the repair process. In some implementations, the real-time repair instructions 44 can be sent to a specific maintenance organization or maintenance personnel that are located closest to the location of the power line disconnection event. Additionally, or alternatively, in some implementations, the real-time repair instructions 44 can be sent to multiple maintenance organizations or maintenance personnel for redundancy in the case of unavailability.

In some implementations, the real-time repair instructions 44 can specify predicted causes of the power line disconnection event alongside predicted tools or materials needed for repairs. These predictions can be based on information included in the real-time alert 22. Specifically, in some implementations, the power sensors 20, such as the power sensor 20-1, can include a measurement evaluator 48. The measurement evaluator 48 can store historical measurement information 50 at the power sensor 20-1 and can use the historical measurement information 50 to more accurately determine whether a power line disconnection event has taken place. The historical measurement information 50 can be a log of prior measurements taken by the power sensor 20-1.

The measurement evaluator 48 can evaluate the power measurements collected for the power line support structure 18-1. Based on the evaluation, the power sensor 20-1 can include an indication in the real-time alert that indicates a likely type of power line disconnection event. For example, if the historical measurement information 50 indicates normal operation followed by complete cessation of power, the measurement evaluator 48 may indicate that a power line was disconnected by inclement weather or environmental factors. For another example, if the historical measurement information 50 indicates normal operation followed by drastic fluctuations in power delivery, the measurement evaluator 48 may indicate that a power line is currently exposed or has been damaged in some manner.

In some implementations, the remedial action module 30 can include an infrastructure handler 52. The infrastructure handler 52 can generate real-time control instructions 54 for a power control device 56. The power control device 56 can be any type of device that can control (and shut off) the power carried via the power lines (e.g., a transformer, an energy generation station, etc.). Based on the real-time alert, the infrastructure handler 52 can generate real-time control instructions 54 that instruct the power control device 56 to shut off power to the affected power line support structures 18.

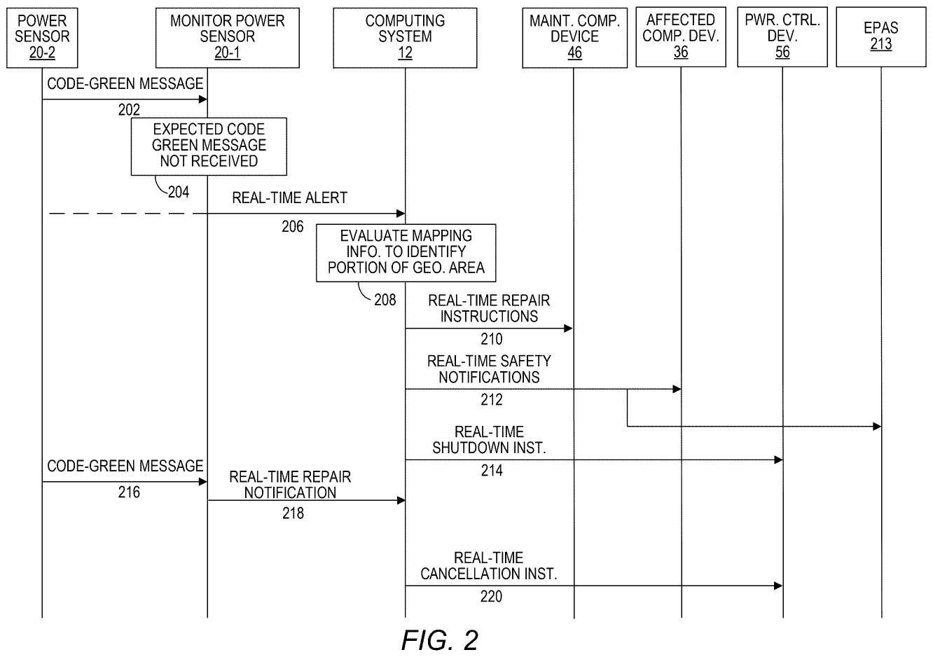

FIG. 2 is a communication flow diagram for automated detection of power line disconnection events and local alerts using wireless procedures according to some implementations of the present disclosure. FIG. 2 will be discussed in conjunction with FIG. 1.

At 202, the power sensor 20-2 can send a “code-green” message to the monitor power sensor 20-1 that monitors the power sensor 20-2. Under normal operating conditions, power sensors can exchange regular “code-green” messages to indicates the healthy state of power lines between power sensors. Alternatively, the power sensor 20-2 can send such messages to monitoring sensors such as the monitor power sensor 20-1. In some implementations, the “monitor” power sensor for another power sensor can be the nearest “upstream” power sensor. For example, the “code green” message may use message codes such as:

| Code | Description | Note |
|---|---|---|
| 100 | All Green | Message Code |
| 997 | Sending sensor identifier | Information Element, carries |
| | | the sending sensor ID. |
| 998 | Destination sensor ident. | Information Element, carries |
| | | the destination sensor ID. |

At 204, the monitor power sensor 20-1 can determine that another code green message expected to be sent after the code green message sent at 202 has not been received. At 206, in response, the monitor power sensor 20-1 can send the real-time alert 22 to the computing system 12. The real-time alert can be a “line disconnected” message generated by the monitor power sensor 20-1 using data received from the power sensor 20-2 as well as local sensor data. The monitor power sensor 20-1 can store an event ID for tracking whether the event has been remedied.

Alternatively, in some implementations, the power sensor 20-2 can send the real-time alert 22 directly to the computing system 12. For example, if the power sensor 20-2 relies upon power or communication via the power line support structure that it monitors, the power sensor 20-2 may be unable to send the code green message to the monitor power sensor 20-1, thus causing the monitor power sensor 20-1 to send the real-time alert 22 at 206. Alternatively, if the power sensor 20-2 has another source of power (e.g., a battery) and/or has other means of communication (e.g., 5G wireless, etc.), the power sensor 20-2 can send the real-time alert to the computing system 12 directly.

In some implementations, the real-time alert 22 sent at 206 can be a “line disconnected” notification. The real-time alert 22 can be generated as a line disconnected notification if the power sensor has not reported any power received for a period of time. For example, a line disconnected notification may utilize message codes such as:

| Code | Description |
|---|---|
| 101 | Line Disconnect - Active Alarm Notification |
| 900 | Event ID (Generated with Timestamp included) |
| 997 | Sending Sensor Identifier |
| 999 | Destination Computing System Identifier |

Alternatively, in some implementations, the real-time alert 22 sent at 206 can be a “line abnormalities detected” notification. The real-time alert 22 can be generated as a “line abnormalities detected” notification if the power sensor has generated power measurements that are outside of expected behavior. For example, a line disconnected notification may utilize message codes such as:

| Code | Description | | | | | | | | | | | | | | | | |
|---|---|---|---|---|---|---|---|---|---|---|---|---|---|---|---|---|---|
| 103 | Line Abnormalities Detected - Active Alarm Notification | | | | | | | | | | | | | | | | |
| 900 | Event ID (Generated with Timestamp included) | | | | | | | | | | | | | | | | |
| 901 | Parameter Indication Flag (16-bit value) | | | | | | | | | | | | | | | | |
| | 15 | 14 | 13 | 12 | 11 | 10 | 9 | 8 | 7 | 6 | 5 | 4 | 3 | 2 | 1 | 0 | ← Bit Position |
| | V-H | V-L | V-N | I-H | I-L | I-N | P-H | P-L | P-N | T-H | T-L | T-N | R | R | R | R | ← Bit Value |

| | |
|---|---|
| | Encoding Notations: |
| | V—Voltage, I—Current, P—Power, T—Temperature |
| | H—High, L—Low, N—Normal |
| 997 | Sending Probe Identifier |
| 999 | Destination Central Server Identifier |

For example, given the above example message codes for line abnormality detection messages, if line temperature is abnormal (e.g., due to ruptured lines), crossed normal threshold due to vegetation/trees rupturing with wires, the encoded message may be “0000000001000000” in binary (0x0040 in Hex).

In some implementations, the real-time alert 206 can be directly provided to devices or system(s) other than the computing system 12 to facilitate remediation of power line disconnection events. For example, 5G Massive Machine Type Communications (mMTC)-capable power sensors can send event reports directly to 3rd party application servers. These application servers can process the data received from these probes using machine learning techniques to derive the appropriate actions and execute remedial actions without manual intervention. Alternatively, in some implementations, 5G capable sensors will send real-time alerts directly to 3rd party application servers using a NEF (Network Exposure Function) API.

At 208, upon receipt of the real-time alert 22, the computing system 12 can evaluate mapping information to identify a particular portion of the geographic area. For example, the computing system 12 can retrieve the mapping information (i.e., line topology information) from a corresponding database and then evaluate the mapping information.

At 210, in some implementations, the computing system 12 can issue real-time repair instructions 44 to maintenance computing device(s) 46 associated with maintenance personnel or organizations.

At 212, the computing system 12 can issue real-time safety notifications 40 to the affected computing devices 36. The computing system 12 can use any type or manner of conventional communication technologies to issue the real-time safety notifications 40 to the affected computing devices 36. Examples of such technologies include mobile alerts to active mobile devices attaching to cell sites covering the affected portion of the geographic area, overlay notifications for local CATV broadcasts, publishing alerts on internet-based local digital/social media, etc. Additionally, or alternatively, in some implementations, at 212, the computing system can issue the real-time safety notifications 40 to an emergency public alert system (EPAS) 213.

At 214, in some implementations, the computing system 12 can issue real-time control instructions 54 to the power control device 56 (e.g., a smart transformer, etc.). The real-time control instructions 54 can instruct the power control device 56 to shut down power to the affected power line support structure.

At 216, the monitor power sensor 20-1 can receive a subsequent code-green message from the power sensor 20-2, thus indicating that the power line support structure monitored by the power sensor 20-2 has been repaired and is now receiving power. In response, at 218, the monitor power sensor 20-1 can send a real-time repair notification to the computing system 12. Upon receipt of the real-time repair notification, at 220, the computing system 12 can issue real-time repair notifications to the affected computing devices 36, the power control device 56, the EPAS 213, etc.

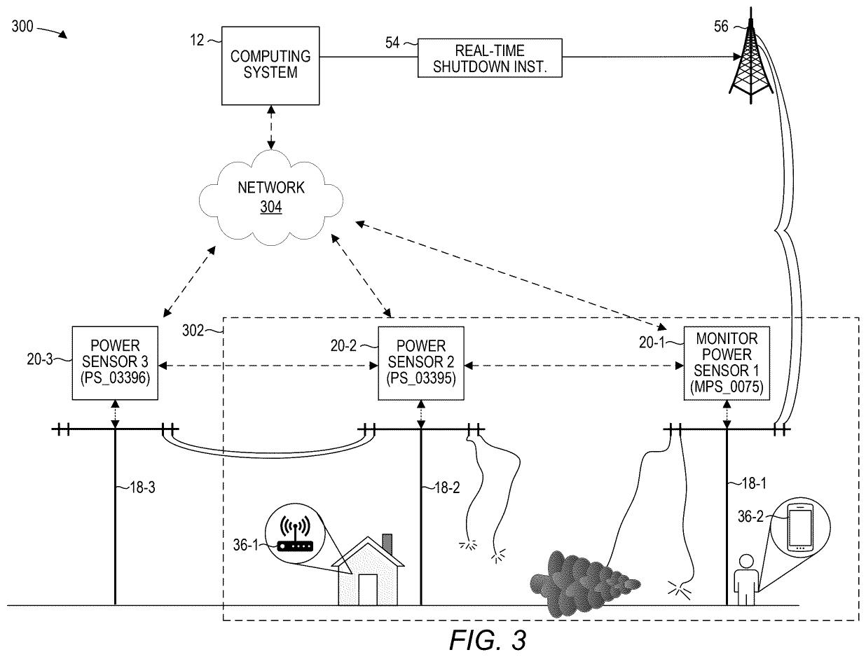

FIG. 3 illustrates an example power line disconnection event and corresponding real-time alerts according to some implementations of the present disclosure. FIG. 3 will be discussed in conjunction with FIG. 1. To follow the illustrated example, a geographic area 300 can include power sensors 20-1-20-3, which monitor power line support structures 18-1-18-3 respectively. As depicted, a power line disconnection event can occur to the power lines supported by the power line support structures 18-1 and 18-2.

In response, the monitor power sensor 20-1 and/or the power sensor 20-2 can transmit the real-time alert 22 to the computing system 12. The computing system can evaluate the mapping information as described with regards to FIG. 1 to identify the portion 302 of the geographic area 300 in which the power line disconnection event occurred. As described previously, the computing system 12 can identify the portion 302 of the geographic area 300 to include the affected computing devices 36.

Once the portion 302 of the geographic area 300 is identified, the computing system 12 can perform remedial actions via a network 304. For example, the computing system can issue the real-time shutdown instructions to the specific power control device 56 that controls power to the power line support structure 18-1. For another example, the computing system can issue real-time safety notifications 40 (not illustrated) to the affected computing device(s) 36.

In some implementations, the computing system 12 can utilize particular communication technologies based on which communication technologies are compatible with corresponding devices of the affected computing devices 36. For example, if the affected computing device 36-1 is a cable TV box, the computing system 12 may use CATV communication protocols to issue the real-time safety notification to the affected computing device 36-1. For another example, if the affected computing device 36-2 is a smartphone device, the computing system 12 may use CATV communication protocols to issue the real-time safety notification to the affected computing device 36-2.

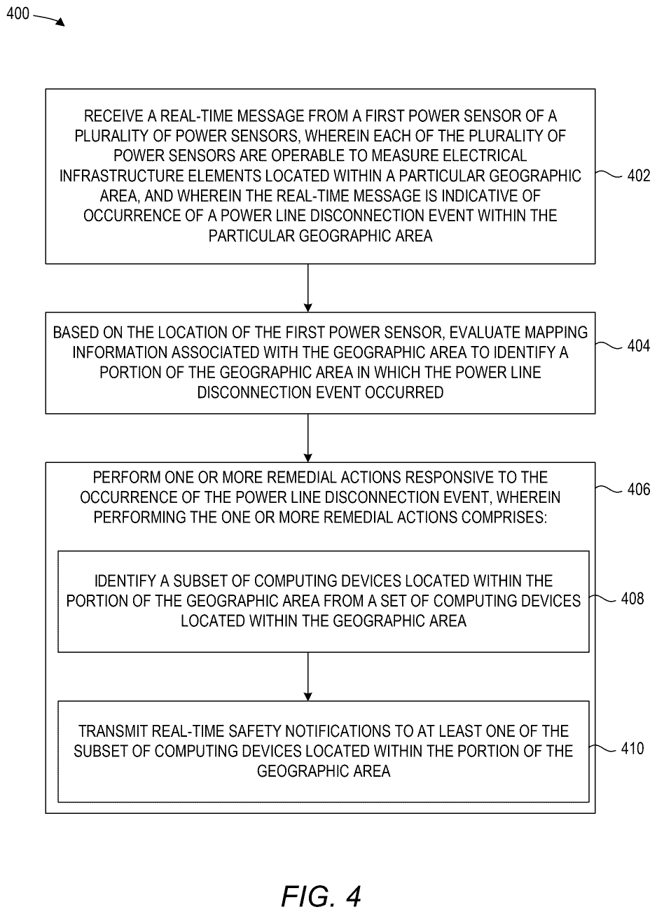

FIG. 4 depicts a flow chart diagram of an example method 400 to perform automated detection of power line disconnection events and local alerts using wireless procedures according to some implementations of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can receive a real-time message from a first power sensor of a plurality of power sensors. Each of the plurality of power sensors can be operable to measure electrical infrastructure elements located within a particular geographic area. The real-time message can be indicative of occurrence of a power line disconnection event within the particular geographic area. In some implementations, the electrical infrastructure elements can include a plurality of power line support structures. In some implementations, receiving the real-time message from the first power sensor of a plurality of power sensors can include receiving the real-time message from the first power sensor via power-line communication (PLC).

In some implementations, each of the plurality of power sensors is communicatively coupled to a corresponding power line support structure of the plurality of power line support structures. Receiving the real-time message from the first power sensor of the plurality of power sensors can include receiving the real-time message from the first power sensor via wireless signaling over a daisy-chained sequence of power sensors of the plurality of power sensors. The wireless signaling over the daisy-chained sequence of power sensors can originate from the first power sensor.

At 404, the computing system can, based on the location of the first power sensor, evaluate mapping information associated with the geographic area to identify a portion of the geographic area in which the power line disconnection event occurred. In some implementations, the electrical infrastructure elements can be or otherwise include a plurality of power line support structures. In some implementations, the power line disconnection event within the particular geographic area is a support structure failure of a first power line support structure.

In some implementations, the first power sensor is communicatively coupled to the first power line support structure. Alternatively, in some implementations, a second power sensor is communicatively coupled to the first power line support structure, and the first power sensor is a monitor power sensor that monitors the first power sensor. In some implementations, receiving the real-time message from the first power sensor of the plurality of power sensors can include receiving the real-time message from the monitor power sensor of the plurality of power sensors. The real-time message indicates that a predetermined amount of time has passed since a communication was last received by the monitor power sensor from the second power sensor.

In some implementations, evaluating the mapping information associated with the geographic area based on the location of the first power sensor to identify the portion of the geographic area in which the power line disconnection event occurred can include identifying, based on the mapping information, the portion of the geographic area that includes the first power sensor and the second power sensor. In some implementations, the mapping information is descriptive of a plurality of predefined portions of the geographic area, and identifying the portion of the geographic area that includes the first power sensor and the second power sensor can include identifying, based on the mapping information, a first predefined portion of the plurality of predefined portions of the geographic area that includes the first power sensor and the second power sensor.

In some implementations, to evaluate the mapping information associated with the geographic area, the computing system can identify a particular power line support structure to which the first power sensor is communicatively coupled from the plurality of power line support structures. The computing system can determine, based on the mapping information, one or more affected power line support structures predicted to be affected by failure of the first power line support structure. The computing system can identify a particular portion of the geographic area including the particular power line support structure and the one or more affected power line support structures as being the portion of the geographic area in which the power line disconnection event occurred.

At 406, the computing system can perform one or more remedial actions responsive to the occurrence of the power line disconnection event.

In some implementations, to perform the remedial action(s), the computing system can cause at least a portion of the electrical infrastructure measured by the first power sensor to cease operation. Additionally, or alternatively, in some implementations, to perform the remedial action(s), the computing system can receive a second real-time message from the first power sensor of the plurality of power sensors. The second real-time message can indicate that the power line disconnection event within the particular geographic area has been remedied. Additionally, or alternatively, in some implementations, to perform the remedial action(s), the computing system can transmit real-time repair instructions to a computing device associated with maintenance personnel.

At 408, to perform the one or more remedial actions, the computing system can identify a subset of computing devices located within the portion of the geographic area from a set of computing devices located within the geographic area.

At 410, to perform the one or more remedial actions, the computing system can transmit real-time safety notifications to at least one of the subset of computing devices located within the portion of the geographic area.

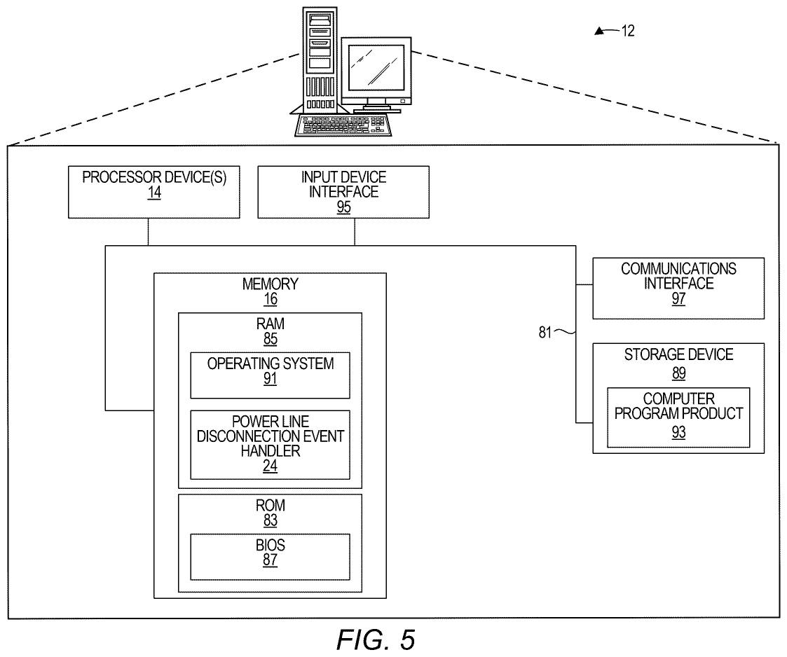

FIG. 5 is a block diagram of the computing system suitable for implementing examples according to one example. The computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 12 includes the processor device(s) 14, the memory 16, and a system bus 81. The system bus 81 provides an interface for system components including, but not limited to, the memory 16 and the processor device(s) 14. The processor device(s) 14 can be any commercially available or proprietary processor.

The system bus 81 may be any of several types of bus structures that may further interconnect to a memory bus (with or without a memory controller), a peripheral bus, and/or a local bus using any of a variety of commercially available bus architectures. The memory 16 may include non-volatile memory 83 (e.g., read-only memory (ROM), erasable programmable read-only memory (EPROM), electrically erasable programmable read-only memory (EEPROM), etc.), and volatile memory 85 (e.g., random-access memory (RAM)). A basic input/output system (BIOS) 87 may be stored in the non-volatile memory 83 and can include the basic routines that help to transfer information between elements within the computing system 12. The volatile memory 85 may also include a high-speed RAM, such as static RAM, for caching data.

The computing system 12 may further include or be coupled to a non-transitory computer-readable storage medium such as the storage device 89, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 89 and other drives associated with computer-readable media and computer-usable media may provide non-volatile storage of data, data structures, computer-executable instructions, and the like.

A number of modules can be stored in the storage device 89 and in the volatile memory 85, including an operating system 91 and one or more program modules, such as the power line disconnection event handler 24, which may implement the functionality described herein in whole or in part. All or a portion of the examples may be implemented as a computer program product 93 stored on a transitory or non-transitory computer-usable or computer-readable storage medium, such as the storage device 89, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the power line disconnection event handler 24 in the volatile memory 85, may serve as a controller, or control system, for the computing system 12 that is to implement the functionality described herein.

Because the power line disconnection event handler 24 is a component of the computing system 12, functionality implemented by the power line disconnection event handler 24 may be attributed to the computing system 12 generally. Moreover, in examples where the power line disconnection event handler 24 comprises software instructions that program the processor device(s) 14 to carry out functionality discussed herein; functionality implemented by the power line disconnection event handler 24 may be attributed herein to the processor device(s) 14.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 95 that is coupled to the system bus 81 but can be connected by other interfaces such as a parallel port, an Institute of Electrical and Electronic Engineers (IEEE) 1394 serial port, a Universal Serial Bus (USB) port, an IR interface, and the like. The computing system 12 may also include the communications interface 97 suitable for communicating with the network as appropriate or desired. The computing system 12 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a computing system comprising one or more processor devices, a real-time message from a first power sensor of a plurality of power sensors, wherein each of the plurality of power sensors are operable to measure electrical infrastructure elements located within a particular geographic area, and wherein the real-time message is indicative of occurrence of a power line disconnection event within the particular geographic area;
based on the location of the first power sensor, evaluating mapping information associated with the geographic area to identify a portion of the geographic area in which the power line disconnection event occurred; and
performing, by the computing system, one or more remedial actions responsive to the occurrence of the power line disconnection event, wherein performing the one or more remedial actions comprises:
identifying, by the computing system, a subset of computing devices located within the portion of the geographic area from a set of computing devices located within the geographic area; and
transmitting, by the computing system, real-time safety notifications to at least one of the subset of computing devices located within the portion of the geographic area.

2. The method of claim 1, wherein the electrical infrastructure elements comprise a plurality of power line support structures.

3. The method of claim 2, wherein receiving the real-time message from the first power sensor of the plurality of power sensors comprises:
receiving, by the computing system, the real-time message from the first power sensor via power-line communication (PLC).

4. The method of claim 2, wherein each of the plurality of power sensors is communicatively coupled to a corresponding power line support structure of the plurality of power line support structures; and
wherein receiving the real-time message from the first power sensor of the plurality of power sensors comprises:
receiving, by the computing system, the real-time message from the first power sensor via wireless signaling over a daisy-chained sequence of power sensors of the plurality of power sensors, wherein the wireless signaling over the daisy-chained sequence of power sensors originates from the first power sensor.

5. The method of claim 2, wherein the power line disconnection event within the particular geographic area comprises a support structure failure of a first power line support structure.

6. The method of claim 5, wherein the first power sensor is communicatively coupled to the first power line support structure.

7. The method of claim 5, wherein a second power sensor is communicatively coupled to the first power line support structure, and wherein the first power sensor comprises a monitor power sensor that monitors the first power sensor.

8. The method of claim 7, wherein receiving the real-time message from the first power sensor of the plurality of power sensors comprises:
receiving, by the computing system, the real-time message from the monitor power sensor of the plurality of power sensors, wherein the real-time message indicates that a predetermined amount of time has passed since a communication was last received by the monitor power sensor from the second power sensor.

9. The method of claim 8, wherein evaluating, based on the location of the first power sensor, the mapping information associated with the geographic area to identify the portion of the geographic area in which the power line disconnection event occurred comprises:
identifying, by the computing system based on the mapping information, the portion of the geographic area that includes the first power sensor and the second power sensor.

10. The method of claim 9, wherein the mapping information is descriptive of a plurality of predefined portions of the geographic area, and wherein identifying the portion of the geographic area that includes the first power sensor and the second power sensor comprises:
identifying, by the computing system based on the mapping information, a first predefined portion of the plurality of predefined portions of the geographic area that includes the first power sensor and the second power sensor.

11. The method of claim 2, wherein evaluating the mapping information associated with the geographic area to identify the portion of the geographic area in which the power line disconnection event occurred comprises:
identifying, by the computing system, a particular power line support structure to which the first power sensor is communicatively coupled from the plurality of power line support structures;
determining, by the computing system based on the mapping information, one or more affected power line support structures predicted to be affected by failure of the first power line support structure; and
identifying, by the computing system, a particular portion of the geographic area including the particular power line support structure and the one or more affected power line support structures as being the portion of the geographic area in which the power line disconnection event occurred.

12. The method of claim 1, wherein performing the one or more remedial actions responsive to the power line disconnection event further comprises:
causing, by the computing system, at least a portion of the electrical infrastructure measured by the first power sensor to cease operation.

13. The method of claim 1, wherein performing the one or more remedial actions responsive to the power line disconnection event further comprises:
receiving, by the computing system, a second real-time message from the first power sensor of the plurality of power sensors, wherein the second real-time message indicates that the power line disconnection event within the particular geographic area has been remedied.

14. The method of claim 1, wherein performing the one or more remedial actions responsive to the power line disconnection event further comprises:
transmitting, by the computing system, real-time repair instructions to a computing device associated with maintenance personnel.

15. The method of claim 1, wherein performing the one or more remedial actions responsive to the power line disconnection event further comprises:
publish, by the computing system, informative content to a media platform, wherein the informative content is indicative of the power line disconnection event.

16. A computing system comprising:
one or more processor devices to:
receive a real-time message from a first power sensor of a plurality of power sensors, wherein each of the plurality of power sensors are operable to measure electrical infrastructure elements located within a particular geographic area, and wherein the real-time message is indicative of occurrence of a power line disconnection event within the particular geographic area,
based on the location of the first power sensor, evaluate mapping information associated with the geographic area to identify a portion of the geographic area in which the power line disconnection event occurred; and
perform one or more remedial actions responsive to the occurrence of the power line disconnection event, wherein, to perform the one or more remedial actions, the one or more processor devices are to:
identify a subset of computing devices located within the portion of the geographic area from a set of computing devices located within the geographic area; and
transmit real-time safety notifications to at least one of the subset of computing devices located within the portion of the geographic area.

17. The computing system of claim 16, wherein the electrical infrastructure elements comprise a plurality of power line support structures.

18. The computing system of claim 17, wherein, to receive the real-time message from the first power sensor of the plurality of power sensors, the one or more processor devices are to:
receive the real-time message from the first power sensor via power-line communication (PLC).

19. The computing system of claim 17, wherein each of the plurality of power sensors is communicatively coupled to a corresponding power line support structure of the plurality of power line support structures; and
wherein, to receive the real-time message from the first power sensor of the plurality of power sensors, the one or more processor devices are to:
receive the real-time message from the first power sensor via wireless signaling over a daisy-chained sequence of power sensors of the plurality of power sensors, wherein the wireless signaling over the daisy-chained sequence of power sensors originates from the first power sensor.

20. A non-transitory computer-readable storage medium that includes executable instructions to cause one or more processor devices to:
receive a real-time message from a first power sensor of a plurality of power sensors, wherein each of the plurality of power sensors are operable to measure electrical infrastructure elements located within a particular geographic area, and wherein the real-time message is indicative of occurrence of a power line disconnection event within the particular geographic area;
based on the location of the first power sensor, evaluate mapping information associated with the geographic area to identify a portion of the geographic area in which the power line disconnection event occurred; and
perform one or more remedial actions responsive to the occurrence of the power line disconnection event, wherein, to perform the one or more remedial actions, the one or more processor devices are to:
identify a subset of computing devices located within the portion of the geographic area from a set of computing devices located within the geographic area; and
transmit real-time safety notifications to at least one of the subset of computing devices located within the portion of the geographic area.
